(19) United States
(12) Patent Application Publication
(10) Pub. No.: US 2016/0335910 A1
(43) Pub. Date: Nov. 17, 2016

(54) Comprehensive Skincare Treatment Plan To Change Skin Type

(71) Applicant: Metabeauty, Inc., Miami, FL (US)

(72) Inventor: Leslie S. Baumann, Miami Beach, FL (US)

(21) Appl. No.: 15/155,945

(22) Filed: May 16, 2016

Related U.S. Application Data
(60) Provisional application No. 62/162,101, filed on May 15, 2015.

(51) Int. Cl. G09B 19/00; G06T 7/00; G09B 5/00

(52) U.S. Cl. CPC G09B 19/00; G09B 5/00; G06T 7/0012; G06T 2207/30088

(57) ABSTRACT

A method for changing the skin type of a consumer/patient to slightly oily, resistant, non-pigmented and tight comprising the steps of: (a) performing a series of baseline instrumental measurements for each of four sets of skin (skin oiliness or dryness; skin sensitivity or lack of sensitivity; even or uneven distribution of skin pigmentation; degree of fine lines and/or wrinkles); (b) determining the skin type based on step (a); (c) communicating the skin type to a consumer/patient or a skin health professional or office staff and recommending a comprehensive treatment plan that includes one or more of topical skincare products, orally-administered dietary supplements, lifestyle modifications, cosmetic and medical procedures appropriate for the particular skin type of the consumer/patient; (d) conducting at least one periodic progress instrumental measurement; (e) analyzing the progress measurement and providing the consumer/user with either “positive”/“reinforcing” feedback or a recommendation for changing the comprehensive treatment plan.

### FIELD OF INVENTION

Methods of improving skin health through a treatment plan that identifies and recommends topical skincare products and/or supplements, medical procedures and lifestyle choices appropriate for a patient's genetically-determined skin type, and tracks the patient's progress in achieving an “ideal” skin type—slightly oily, non-sensitive, non-pigmented and tight (non-wrinkled).

### CROSS REFERENCE TO RELATED APPLICATIONS

The present application is related to and claims the benefit of priority from, U.S. Provisional Patent Application Ser. No. 62/162,101 filed May 15, 2015, the content of which is incorporated by reference in its entirety.

### BACKGROUND OF THE INVENTION

The terms “oily”, “dry” and “sensitive” as used in prior art skincare methods (products and/or procedures) have a number of drawbacks. Each of these terms, per se, is subjective, and susceptible to differing meanings.

There are different types or degrees of “oily” skin; moreover, the term “oily” can have a negative connotation. In accordance with the methods of the present invention, “very oily skin” is determined instrumentally, and should be treated. However, “slightly oily” skin is desirable, and once attained should be maintained. When the outermost layer(s) of skin is/are “slightly oily”, an outer barrier, comprised of surface lipids and naturally occurring antioxidants, is formed. This barrier retains moisture and serves to protect the underlying tissue from environmental injury (e.g., pollutants, allergens, ultraviolet radiation).

In contrast to “oily” skin, dry skin has fewer surface lipids, resulting in compromised/reduced skin barrier function and increased transepidermal water loss. Additionally, dry skin has lower levels antioxidants, less natural moisturizing factor, less free water to activate enzymes and a less protective bilayer membrane, making it more vulnerable to entry by irritants and allergens and more susceptible to dehydration.

In the absence of objective measures, the term “sensitive” is especially subjective, and is among most misused or overused terms not only by consumers but also by dermatologists and skin health professionals. Indeed, there are multiple subtypes of “sensitive” skin, each requiring distinct treatment regimens.

To avoid the often misdescriptive, subjective use of the terms “dry”, “oily”, “sensitive”, the methods of the present invention employ diagnostic instruments, including means for visual image analysis. Visual image analysis is also used in the methods of the present invention to determine whether skin is pigmented or non-pigmented, or wrinkle or tight (i.e., non-wrinkled).

By employing instrumental techniques in conjunction with the methods of education and training of the present invention, allied skin health professionals and skincare consumers (both products and services) can transform a genetically determined skin type to an ideal skin type—designated “ORNT”—that is slightly oily, resistant (not sensitive), non-pigmented (even-toned) and tight (not wrinkle-prone).

Integral to the methods of the present invention for objective (instrumental) determination of skin type is a system of communicating topically-applied skincare products (topically-applied creams, lotions, serums, gels, etc.), prescription medications (oral, topical and injectable), nutritional supplements, cosmetic and medical procedures (e.g., injectable fillers, toxins, facials) and recommendations for changes to lifestyle (e.g., diet, exercise, sleep duration) for each of the sixteen skin types by providing the consumer/patient with one, two, or preferably three of the following simplified, unique skin type identifiers: (i) one of sixteen four-letter sequences, formed from four pairs of letters, where each letter is different; (ii) one of sixteen different colors corresponding to the one of sixteen four-letter sequences; (iii) one of sixteen Arabic numerals—one through sixteen—where each number corresponds to one of the sixteen four-letter sequences in (i) and one of the sixteen different colors in (ii).

### BRIEF DESCRIPTIONS OF DRAWING

FIGS. 1 and 2 show an information sheet provided to or used by a patient/consumer, skin health professional or office staff. More particularly, the sheet shows the sixteen skin types used in practicing the methods of the present invention. Each of the sixteen skin types is expressed as a unique four-letter sequence, which corresponds to a single number (1-16), which is presented within a scalloped octagon. The number and four-letter sequence are each presented against a color specific to that skin type.

FIG. 3 shows a point-of-sale system used in displaying products that are to be prescribed for and used by patients/consumers with one of sixteen specific skin types. The specific skin types are shown as four-letter sequences, together with a number within a scalloped octagon corresponding to a skin type, against a specific color associated with that skin type. The display may be used, for example, in the office of skin health professional, or retail establishment (e.g., salon at which skincare services are provided).

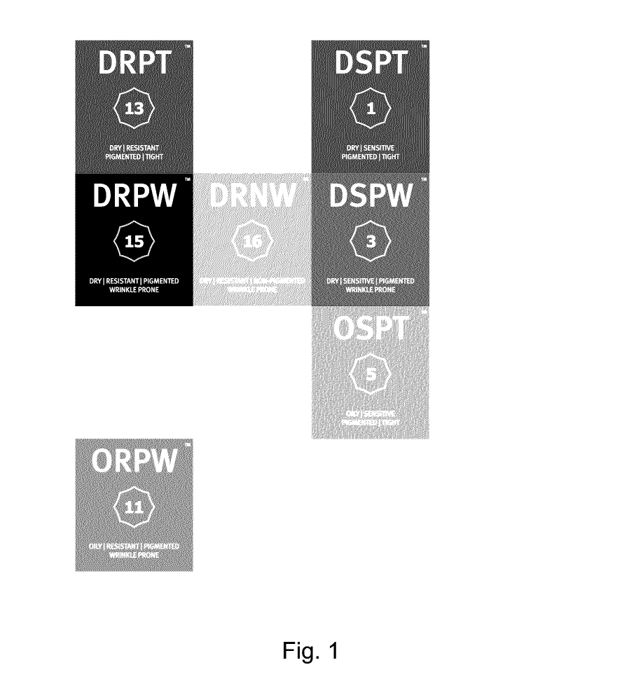

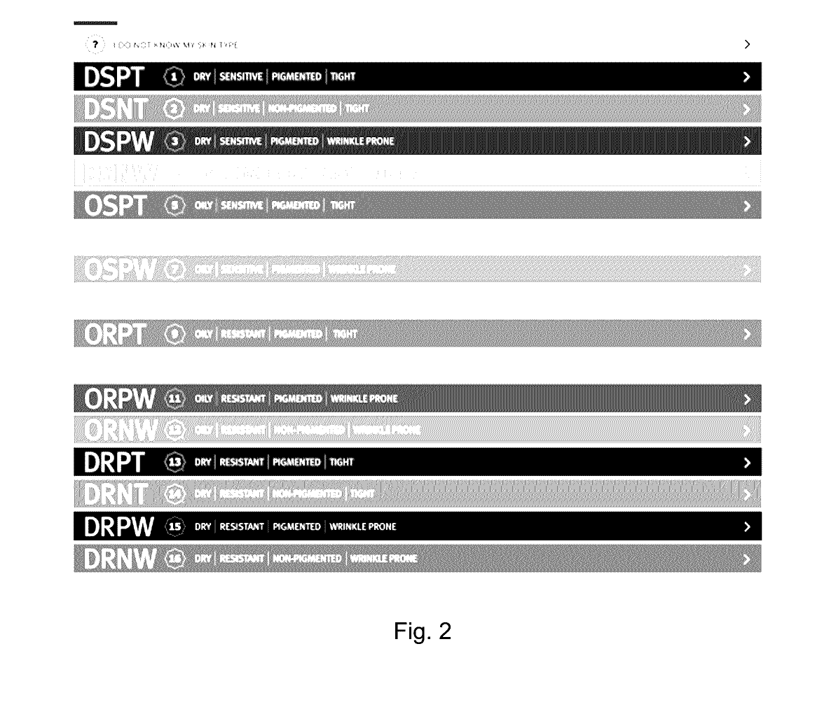

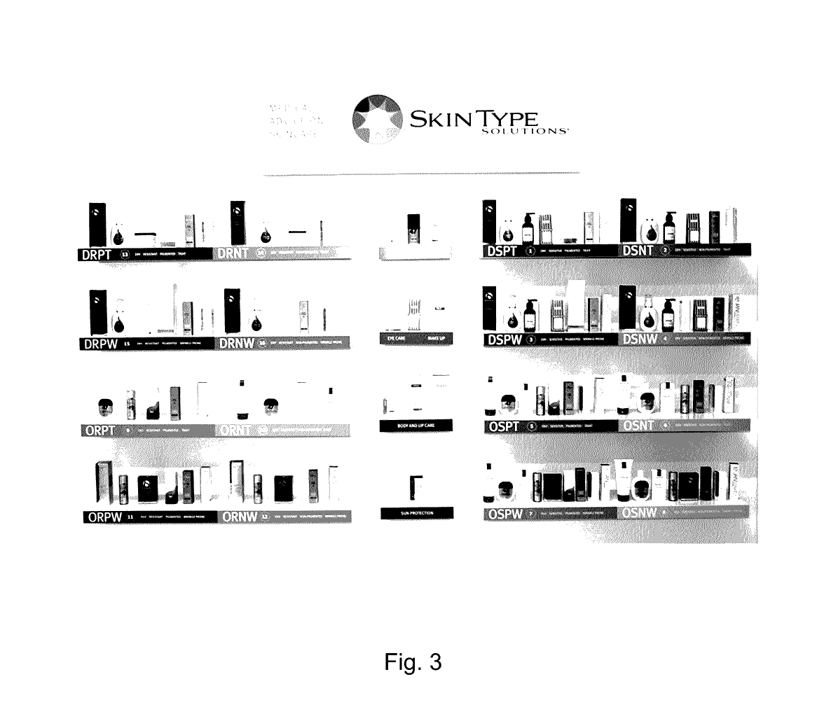

### DETAILED DESCRIPTION OF THE INVENTION

The present invention is directed to methods for improving skin health in patients/consumers—more particularly, changing a person's genetically determined skin type to an ideal skin type—oily, resistant, non-pigmented and tight—by educating and providing feedback to both skin health professionals, including medical office staff and end-users (patients/consumers), to determine and implement a comprehensive treatment plan that includes skincare products, prescription medications (oral, topical, and injectable), cosmetic and medical procedures (as defined below), nutritional supplementation, and recommended lifestyle changes that are appropriate for one of sixteen specific skin types, where each skin type is defined using instrumental measurements of four pairs of clinical skin characteristics: oily (“O”) or dry (“D”); sensitive (“S”) or resistant (“R”); pigmented (“P”) or non-pigmented (“N”); and wrinkle-prone (“W”) or tight (“T”).

Optionally, but preferably, in addition to instrumental measurement, the determination of the clinical skin characteristics is further determined via a clinically validated questionnaire.

In preferred embodiments, the feedback step of the methods of the present invention employs digital communication technologies (e.g., email, text message, apps) that allow a patient/consumer and skin health professional to (i) interactively track compliance with the prescribed comprehensive treatment plan. “Progress” may be tracked not only in comparison to the “baseline” of the patient/consumer, but also with respect to others of the same skin type and (ii) adjust the treatment plan as needed (e.g., by changing amount, frequency, or type of products/medications, or employing a cosmetic or medical treatment performed by a skin health professional.

Certain terms used in describing the methods of the present invention are to be understood as having the meanings set out below.

“Skin health professional” means a physician, in particular a dermatologist or plastic surgeon, a nurse (LPN or RN), a licensed medical assistant or licensed aesthetician.

“Office staff” means a person other than a skin health professional (such as a receptionist or cashier) that interacts with a consumer in a setting in which a consumer (also to understood, and referred to synonymously, as a “patient”) receives or purchases skincare products or services.

“Skincare services” means a medical or cosmetic procedure or treatment, including the dispensing of topically-applied, injected or orally-administered products, including supplements, or the use of medical devices such as lasers, lights, radiofrequency, ultrasound, cryogen, or injectable dermal fillers and neuromuscular blocks (e.g., botulinum toxin) which when administered by or to a consumer/patient help achieve or maintain slightly oily, resistant, non-pigmented and tight skin.

“Supplement” means a products taken by mouth that contain a “dietary ingredient”. “Dietary ingredients” include vitamins, minerals, amino acids, and herbs or botanicals, as well as other substances that can be used to supplement the diet. Supplements used in practicing the methods of the present invention may be administered (i.e., taken) in a variety of dosage forms including capsules, tablets, powders, liquids, teas, coffees, candies or gums.

“Treatment Plan” means a printed, written, or digitally displayed plan with specific instructions as to when [i.e., frequency with which consumer/patient is to follow instructions—number of day(s) per week or month or other period of time, and if multiple times during a specific day, when (e.g., morning, evening)]. The treatment plan may consist of one or a combination of the following: (1) a skincare regimen comprising non-medicated skincare products, with instructions for dosing (i.e., amount), timing (e.g., morning, evening) and duration of application (e.g., rub in for 30 seconds); and for a regimen comprising multiple products, the order in which the products are to be applied, and time to wait between application of different products) each product; (2) an oral supplement regimen comprising dosing (i.e., amount) and timing (e.g., morning or evening; before, with, or after meal); and for a regimen comprising multiple products, the order in which the products are to be ingested, and time to wait between the same); (3) prescription medications (topical or oral or injectable) with instructions for dosing, timing, and duration of application (e.g., rub in topical product for 30 seconds); and for a regimen comprising multiple products, the order in which the products are to be applied, and time to wait between application of different products) each product; (4) diet suggestions, which foods and beverages should be consumed or avoided; and (5) lifestyle habits such as smoking cessation strategies, sleep duration, meditation, exercise, visualization techniques, sun avoidance, and use of sun protective clothing.

As further described below, one of sixteen skin types is assigned to a consumer based on instrumental measurements the following skin attributes: Oiliness (sebum production) Dryness (skin barrier integrity); Sensitivity (inflammation);

Pigmentation (even or uneven distribution of melanin); Appearance of wrinkled skin (fine facial lines and/or wrinkles) and/or tendency to wrinkle (expressed, for example, in measurement of levels of antioxidants, DNA repair enzymes, cytokines, stem cells (such as CD271+ cells), Mitochondrial complex II function, and genes that code for extracellular matrix proteins (e.g., elastin, collagen) as well as genes that code for enzymes that breakdown extracellular matrix (e.g., matrix metalloproteinases, which breakdown interstitial collagens, types I, II, and III; hyaluronidase, and elastase).

Skin is determined to be “oily” based on one or more of the following measurements which can be administered by a skin health professional in an office or retail setting, or self-administered by a consumer at home.

In practicing the methods of the present invention, the degree of “oiliness” is a function of the amount of sebum secretions on a consumer's face or hair. In preferred embodiments of the present invention, a Sebumeter®, a handheld, electronic diagnostic instrument available from Courage+Khazaka Electronic GmbH (Cologne, Germany) is used to measure “oiliness” based on “grease spot photometry”. More particularly, a piece of matte tape is dispensed from a holder, and placed in contact with the surface of the skin or hair. After contact for a specified time interval, the tape becomes transparent in relation to the amount of sebum on the skin or hair. Using a photocell, the amount of light transmission is measured, and correlated with the amount (i.e., degree) of sebum. See, e.g., S W Youn et al. “Evaluation of facial skin type by sebum secretion: discrepancies between subjective descriptions and sebum secretion,” Skin Res. Technol. Vol. 8, No. 3, pp. 168-72 (August 2002). (Other devices for calculating sebum levels, including Sebutape®, or comparable technology (e.g., SebuFix®), each as describecan also be used in accordance with the methods of the present invention.)

Alternatively, or in addition to using a Sebumeter,® “shininess” of skin (or light refelction)—which is also indicative of degree of “oiliness”—can be measured visual image analysis software. In embodiments of the invention that assess shininess, an image of the skin is captured, preferably about twenty minutes after washing; the image is uploaded to, or saved on, an electronic device having an imaging means (e.g., video or still camera), and scored using visual image analysis software.

Sebutape®—a polymeric film entrained with air microcavities, available from CuDerm, Corp. (Dallas, Tex.)—is another measurement of skin oiliness that may be used in practicing the methods of the present invention. One side of the film is coated with a lipid-porous adhesive, which enables the film to be affixed to the skin during a sampling (i.e., contact) period. As sebum reaches the skin surface, it is rapidly absorbed into the film. Air within the microcavities is displaced by sebum. The sebum-filled cavities, in turn, become transparent. Additionally, sebum output forms a “spot”, corresponding in size to the volume of the droplet. See, e.g., A M Kligman et al., “Sebutape: A device for visualizing and measuring human sebaceous secretion,”J. Soc. Cosmet. Chem., Vol. 37, pp. 369-374 (September/October 1986). Sebufix® foil, available from Courage+Khazka, absorbs sebum from the skin surface within the micropores, displaying the sebum as “spots” of different. The foil is mounted on a video camera, which records sebum production over a defined period of time.

“Oiliness” may also be assessed by taking a specimen of bodily fluid (e.g., saliva or mucosal cells lining the oral cavity) or stratum corneum cells obtained by tape stripping methods and measuring the level of expression of one or more genes associated with increased sebum production, as well as measurements that evaluate DNA, RNA, protein or lipid content.

For purposes of the present invention, the degree of “oiliness” is preferably differentiated between “slightly oily” or “very oily”, where “slightly oily” skin is characterized by an amount of sebum minimally sufficient to create an effective occlusive barrier, a protective coating that prevents entry of allergens and irritants, and limit transepidermal water loss, but not an amount of sebum on the skin's surface that would cause shininess, acne and/or an unpleasant sticky sensation.

In preferred embodiments, in addition to one or both of measuring sebum content (preferably, using a Sebumeter®) or skin shininess (using visual image analysis), oiliness is also assessed using clinically-validated assessment tool (e.g., questionnaire) which may be (a) self-administered by a consumer using an interactive electronic device (including, virtual reality device), a computing device (including tablet computers), a gaming console, a “smart” mobile phone, or other telecommunication device) or (b) trained skincare professional

Two non-limiting examples of clinically-validated questionnaire are described in the following publications: Baumann, et al., “A Validated Questionnaire for Quantifying Skin Oiliness”, Journal of Cosmetics, Dermatological Sciences and Applications, Vol. 4, pp. 78-84 (2014); U.S. Patent Application Pre-Grant Publication 2006/0265244, Appendix, Table 2 (score between 34-44 indicates “very oily” skin; score between 27-33 indicates “slightly oily” skin)

For purposes of practicing the methods of the present invention, skin is classified as “dry” based on or more of the following instrumental measurements. Skin hydration status may be measured based on changes in dielectric constant due to skin surface hydration. In preferred embodiments skin hydration is measured with a Corneometer®, a hand-held probe from Courage+Khazaka Electronics GmbH.

In place of, or in addition to, skin hydration measurement with a Corneometer®, skin dryness can be measured in terms of transepidermal water loss (TEWL), using a handheld probe that measures water evaporation from the skin. Preferably, a Tewameter® from Courage+Khazaka Electronics GmbH is used. More particularly, the Tewameter® measures the density gradient of water evaporation from the skin indirectly by the two pairs of sensors (temperature and relative humidity) inside a open chamber (hollow cylinder). Evaporation is expressed as change in water transported (dm) over time (dt) according to the following formula:

$$\frac{d m}{d t} = - D \cdot A \cdot \frac{d p}{d x}$$

where A=surface [m²]; m=water transported [grams]; t=time [hours]; D=diffusion constant [=0.0877 g/m(h(mm Hg))]; p=vapour pressure of the atmosphere [mm Hg]; x=distance from skin surface to point of measurement [meters].

In addition to, or in place of direct measurement of skin hydration, for purposes of practicing methods of the present invention, dryness may be assessed by visual or computer image analysis of skin roughness, also known in the art as topographic analysis of skin texture.

In addition to skin hydration and/or surface topography measurements, skin dryness may be assessed by taking a specimen of bodily fluid (e.g., saliva or mucosal cells lining the oral cavity) or stratum corneum cells from the epidermis via tape stripping and measuring the level of expression of one or more gene(s) associated with skin barrier function, including, but not limited to, a gene that codes for one or more of: filaggrin; 3-hydroxy-3-methylglutaryl coenzyme A (HMG-CoA) reductase; a sterol regulatory element-binding protein (SREBP), such as SREBP-2; a gene that plays a role in ceramide synthesis, such as serine palmitoyltransferase; a gene that plays a role in fatty acid synthesis, such as ALOX15B (Arachidonate 15-lipoxygenaseor INSIG1 (insulin induced-gene-1 protein).

In preferred embodiments, in addition to the above measurements, skin can also be assigned a clinical characteristic of “dry” based on the oily/dry score in clinically-validated questionnaire. See, e.g., U.S. Patent Application Pre-Grant Publication 2006/0265244, Appendix, Table 2 (score between 11 and 26 represents dry skin).

For the purposes of the present application, the term “sensitive” skin is be understood to mean hyperactivity of the skin's inflammatory pathways to insults such as dehydration, infective agents, allergens and irritants, resulting in skin inflammation and further manifested as papules, pustules, redness (erythema), itching, burning, stinging or scaling. Further, “skin sensitivity” should be understood to be independent of erythematous response to sun exposure, and not to encompass sunburn.

In accordance with methods of the present invention, skin is determined to be “sensitive” based on one or more of the following: (a) measurement of diffuse redness (e.g., from vasodilation) or erythema using a clinically-validated assessment scale that measures the shade of redness and the percent of facial surface area that is affected; (b) spectrophometric analysis of skin redness/erythema; (c) computer image analysis of macule/papule/pustule/comedone number and/or lesion count; and/or (d) patient self-reported history of one or more of: acne, rosacea, stinging, contact or irritant dermatitis, (e) clinical-grade image analysis that measures erythema and assigns a numerical score (such as the VISIA®-CR system from Canfield Imaging Systems, Parsippany, N.J.).

In addition to the above-described methods, skin may also be determined to be “sensitive” and assigned an “S” versus “R” designator based on one or more of the following: (i) a positive response to either a lactic acid stinging test or a patch test for contact or irritant dermatitis; (ii) measurement of histamine release (e.g., by cutaneous microdialysis) or inflammatory cytokine levels such as IL-1, IL-6, IL-8, IFN-gamma and TNF-alpha; (iii) measurement of expression level of (a) a gene or a single-nucleotide polymorphism (SNP) associated with rosacea, such SNP rs763035 and SNP rs111314066, or (b) a gene associated with one or more of acne, stinging sensation upon application of a low pH substance, or susceptibility to contact or irritant dermatitis, or (c) a gene associated with control of mast cell mediated histamine release and regulation of pro-inflammatory cytokines such as IL-1, IL-6, IL-8, IFN-gamma and TNF-alpha, or (d) a gene associated with activation and control of the arachidonic acid cascade and prostaglandin production, or the presence of P. acnes bacteria as detected under ultraviolet or Wood's light or using a visual imaging such as Canfield's RBX® Technology.

As used in the present application, “pigmented” skin is to be understood as an uneven distribution of melanin-containing melanosomes, which may present as blotches or patches of darker or lighter skin tone. This may be due to melasma, post-inflammatory hyperpigmentation or photodamage.

A determination of whether skin is pigmented or non-pigmented in accordance with methods of the present invention is made based on one or more of instrumental analysis of melanin content using a spectrophotometer, chromameter, Tewameter® (as further described below) or computer imaging analysis of a clinical photograph taken at a specified wavelength.

In one preferred embodiment, a Mexameter® (Courage+Khazaka) or spectrophotometer a hand-held probe for measuring skin color is used. More particularly, the probe tip is placed in contact with the skin surface. Specific light wavelengths, chosen to correspond to different absorption rates by skin pigments, are emitted onto the skin. A receiver measures the quantity of light reflected by the skin. Reflectance, in turn, is used to express the quantity of light absorbed by the skin.

In accordance with the methods of the present invention, skin is determined to be “wrinkle-prone” based on digital images and computer analysis of skin texture as well as depth, width, and/or length of wrinkles/fine lines. In certain embodiments, a digital image is scanned (i.e., horizontally and vertically) to collect/evaluate red, green and blue intensities of the pixels that comprise the image. Mathematical algorithms calculate a texture score based on the totals of the mean intensities of the red, green and blue pixels. Algorithms also calculate number, length and depth of fine lines and wrinkles.

In addition to electro-optical methods as described above, skin may also be classified as pigmented (or non-pigmented) or wrinkle-prone (or tight) based on genetic analysis. In making a determination of whether skin is (not) pigmented, bodily samples may be taken and analyzed for levels of expression of genes associated with melanin production, not limiting examples of which include, TYR, DCT and MITF. A determination of whether skin is (not) wrinkle-prone, bodily samples may be taken and analyzed for levels of expression of genes associated with level of one or more genes associated with collagen, elastin, or hyaluronic acid such as the genes that control production of the enzymes collagenase, elastase, matrix metalloproteinases and hyaluronidase and the genes that regulate collagen, elastin and hyaluronic acid and extracellular matrix production. Bodily fluids or stratum corneum cells (obtained from tape stripping) may also be assessed for levels of eumelanin and pheomelanin and their byproducts (such as amino acids), antioxidants, AGEs (Advanced Glycation Endproducts), and DNA mutations.

In addition to the above electro-optical and genetic testing methods, assessment of whether skin is (not) pigmented or is (not) wrinkle-prone may also be made using a clinically-validated assessment tool or scale. Non-limiting examples of assessment tools are disclosed in the following publications: D. Shoshani, “The modified Fitzpatrick Wrinkle Scale: a clinical validated measurement tool for nasolabial wrinkle severity assessment” Dermatol Surg. Vol. 34 (Suppl. 1), pp. S85-91 (2008); A. Carruthers et al., “A validated grading scale for crow's feet” Dermatol Surg. Vol. 34 (Suppl. 2), pp. S173-S178 (2008); D J Day et al. “The wrinkle severity rating scale: a validation study,” Am J Clin Dermatol, Vol. 5, pp. 49-52 (2004).

In practicing the methods of the present invention, one or several of the probes described above may be provided to a consumer (for use at home) or to the skin health professional (for use by that professional, or under the professional's guidance by office staff), or to a retail store (for use in the store by consumers or a technician trained in the use of the probe and assigned to test customers in the store) or to a kiosk (stand alone unit placed in areas of high foot traffic.). The probes may, and preferably are connected to a computing device—including a smartphone, a tablet computer, or other mobile telecommunication device—which stores the consumer's data/scores.

Similarly, a clinically-validated assessment tool (i.e., questionnaire/test) used in practicing the methods of the present invention may administered in a variety of settings, preferably using a computing device (as defined above), most preferably a mobile computing device. In some embodiments, the test is administered at home. In some embodiments, the test may be administered in a doctor's office. In some embodiments, the test may be administered in a retail setting.

In preferred aspects of the invention, a questionnaire evaluating the lifestyle of a patient/consumer is administered to track not only compliance with the prescribed skincare regimen (i.e., usage of the products in the intended manner), but also smoking, diet, sleep patterns, levels of activity (e.g., calories burned, exercise in a gym or while participating in a sport, “steps” per day), as well as levels of sun exposure (for example, as measured on a wearable electronic device).

A first step in the methods of the present invention is correctly identifying the skin type of a patient/consumer as one of sixteen types—OSPW, OSNW, OSPT, OSNT, ORPW, ORNW, ORPT, ORNT, DSPW, DSNW, DSPT, DSNT, DRPW, DRNW, DRPT, or DRNT, each as defined below.

DSPT dry, sensitive, pigmented, tight
DSNT dry, sensitive, non-pigmented, tight
DSPW dry, sensitive, pigmented, wrinkle-prone
DSNW dry, sensitive, non-pigmented, wrinkle-prone
OSPT oily, sensitive, pigmented, tight
OSNT oily, sensitive, non-pigmented, tight
OSPW oily, sensitive, pigmented, wrinkle-prone
OSNW oily, sensitive, non-pigmented, wrinkle-prone
ORPT oily, resistant, pigmented, tight
ORNT oily, resistant, non-pigmented, tight
ORPW oily, resistant, pigmented, wrinkle-prone
ORNW oily, resistant, non-pigmented, wrinkle-prone
DRPT dry, resistant, pigmented, tight
DRNT dry, resistant, non-pigmented, tight
DRPW dry, resistant, pigmented, wrinkle-prone
DRNW dry, resistant, non-pigmented, wrinkle-prone

As part of the first step in the methods of the present invention, the consumer's skin type is stored as an electronic record—a consumer skin type profile (STP). The consumer's STP may be accessed by one or more of the consumer herself/himself, as well as her/his skin health professional and/or office staff.

The STP includes at least the following information for the consumer: name; contact information—one or more of phone number, email address, physical (i.e., mailing address) and 4-letter skin type designation.

In preferred embodiments, the STP includes at least one, more preferably at least two, still more preferably at least three of: (i) year of birth; (ii) gender; (iii) skin sensitivity subtype (e.g., acne, rosacea), (iv) geographic location of where (a) the patient/consumer resides, (b) where the data (e.g., from follow-up) was recorded.

In especially preferred embodiments, the consumer's STP includes answers to a clinically-validated questionnaire authored by the inventor and published as “Understanding and treating various skin types: the Baumann Skin Type Indicator,” Dermatol Clin. 2008:26(3):359-73, or as an appendix to The Skin Type Solution (Bantam, 2006).

A second step in the methods of the present invention is directed to communicating to a consumer/patient, skin health professional and/or office staff, the unique skin type of the consumer (as enumerated above) and the recommended comprehensive treatment plan appropriate for that specific consumer's skin type—namely, one or more of: (i) topically-applied, non-medicated skincare product(s); (ii) dietary or nutritional supplements, (iii) medicated skincare product(s) (over-the-counter, or prescription; topical, oral and/or injectable); (iv) cosmetic or medical procedure(s) (as defined below); and recommendation(s) for lifestyle changes (e.g., diet, sleep, exercise).

In this step of the invention, the sixteen skin types are preferably represented by a single number, ranging from 1 to 16: DSPT=1; DSNT=2; DSPW=3; DSNW=4; OSPT=5; OSNT=6; OSPW=7; OSNW=8; ORPT=9; ORNT=10; ORPW=11; ORNW=12; DRPT=13; DRNT=14; DRPW=15; and DRNW=16.

For consumers having one of the following skin types, the second step in the methods of the present invention is directed to communicating to a consumer/patient, skinhealth professional and/or office staff, skincare products (topical and oral) and lifestyle habits, diet, supplements, prescription medications, cosmetic treatments, prescription medical facials and medical procedures that are appropriate for changing the consumer's skin to slightly oily, resistant, non-pigmented and tight from the following skin types: DSPT (1); DSNT (2); DSPW (3); DSNW (4); OSPT (5); OSNT (6); OSPW (7); OSNW (8); ORPT (9); ORPW (11); ORNW (12); DRPT (13; DRNT (14); DRPW (15); and DRNW (16).

For consumers with a skin type of ORNT (10), where the consumer's skin is very oily, the second step in the methods of the present invention is directed to communicating to a consumer/patient, skin health professional and/or office staff the skincare products (topical and oral) and lifestyle habits, diet, supplements, prescription medications, cosmetic treatments, prescription medical facials and medical procedures that are appropriate for changing the consumer's skin to slightly oily, resistant, non-pigmented and tight.

For consumers with a skin type of ORNT (10), where the consumer's skin is slightly oily, the second step in the methods of the present invention is directed to communicating to a consumer/patient, skin health professional and/or office the skincare products (topical and oral) and lifestyle habits, diet, supplements, prescription medications, cosmetic treatments, prescription medical facials and medical procedures that are appropriate for maintaining the consumer's skin as slightly oily, resistant, non-pigmented and tight.

In practicing the second step of the inventive methods, the skin type number—which communicates to a consumer/patient or skin health professional or office staff which skincare products (topical and oral) and lifestyle habits, diet, supplements, prescription medications, cosmetic treatments, prescription medical facials and medical procedures are appropriate (i.e., recommended) for use by a particular consumer/patient—is placed prominently on one or more of (i) skincare packaging, either primary packaging (bottle, tube, jar) and/or secondary packaging (outer box, bag or wrap enveloping/containing the bottle, tube, jar or (ii) educational materials (written, in digital media or print, as well as audio and/or video format) describing skincare products (topical and oral) and lifestyle habits, diet, supplements, prescription medications, cosmetic treatments, prescription medical facials including descriptions of cosmetic and medical procedures performed by a skin health professional, or office staff (under the direction or at the instruction of the skinhealth professional), (iii) point of sale display (e.g., shelfing), (iv) website, including one or more “microsites”, and/or social media platforms, (v) “app” installed on a computing device, (vi) kiosk or vending machine, (vii) game (electronic/video, board or role-playing game), (viii) monitors in waiting rooms, exam rooms, airports, lobbies and other public spaces.

The educational materials may be in the form of printed material(s)—e.g., brochure, pamphlet, questionnaire, newsletter, catalog—games (e.g., board games), interactive games (e.g., video or role-playing, for individual or multiple gaming participants) or video (internet, streaming, or television). In preferred embodiments, the educational material is provided in electronic format such that the printed material(s) may be downloaded, saved and/or printed, emailed, or displayed on the screen of a computer or mobile telecommunications device (tablet computer, smart phone) virtual reality goggles/glasses, or wearable electronic device having a display screen (watch/bracelet) and means for sending and receiving information from the internet, either by direct wi-fi or cellular connectivity, or blue-tooth connectivity to a mobile telecommunications device that has wi-fi or cellular connectivity.

In more particularly preferred embodiments of the present invention, the communication step is practiced by displaying the unique skin type number on one of sixteen corresponding unique color backgrounds, each expressed below in terms of CYMK value, RGB color code and/or corresponding hex code.

| Number | Color | CYMK | RGB Color | Hex Code # |
|---|---|---|---|---|
| 1 | Purple | 21.71.0.0 | 166.94.48 | A65E94 |
| 2 | Pink | 0.50.0.0 | 216.138.174 | D88AAE |
| 3 | Blush | 0.75.24.0 | 203.93.119 | CB5D77 |
| 4 | Peach | 0.32.26.2 | 222.167.150 | DEA796 |
| 5 | Orange | 0.50.58.0 | 214.135.98 | D68762 |
| 6 | Beige | 0.18.26.0 | 238.200.167 | EEC8A7 |
| 7 | Melon | 0.31.73.0 | 226.168.87 | E2A857 |
| 8 | Yellow | 0.10.41.0 | 245.218.149 | F5DA95 |
| 9 | Lime | 34.0.99.0 | 171.195.63 | ABC33F |
| 10 | Green | 22.0.49.0 | 195.214.144 | C3D690 |
| 11 | Leaf | 53.2.84.0 | 134.177.90 | 86B15A |
| 12 | Teal | 38.0.32.0 | 160.200.71 | A0C8AB |
| 13 | Aqua | 69.19.16.5 | 97.148.176 | 6194B0 |
| 14 | Azure | 36.15.0.0 | 156.177.216 | 9CB1D8 |
| 15 | Blue | 73.45.5.0 | 89.112.163 | 5970A3 |
| 16 | Lilac | 29.32.0.0 | 164.152.193 | A498C1 |

Red tones are associated with dry, sensitive skin types, and are numbered 1-4.

Orange tones are associated with oily, sensitive skin types, and are numbered 5-8.

Green tones are associated with oily, resistant skin types, and are numbered 9-12.

Blue tones are associated with dry, resistant skin types, and are numbered 13-16.

In an especially preferred embodiment, the unique skin type color and corresponding skin type number are displayed within a distinct shape, preferably a bounded (i.e., closed) geometric shape, most preferably within a scalloped octagon.

In a third step of the present invention, after a consumer's skin type is determined (i.e., by one or a plurality of instrumental measurements, where each instrumental test is used to determine a particular skin type pairing—oily or dry; sensitive or resistant; pigmented or non-pigmented; wrinkle-prone or tight), one or a plurality of periodic instrumental measurements of progress (or lack of progress) in transforming the consumer's skin to slightly oily, resistant, non-pigmented and tight (or in case of Type 10 skin, maintaining all four of the ORNT attributes) are made.

These “progress” instrumental measurements may be made by a consumer/patient himself/herself (e.g., at home or in a kiosk in a retail environment), or by a skinhealth professional or office staff in a medical office or licensed skincare establishment (e.g., salon or spa).

At least one, preferably two, still more preferably three, most preferably four instrumental measurement(s), may, and in preferred embodiments, is/are performed by recording and storing an electronic (digital) image of the consumer's skin and, via computer software, comparing changes between a current digital image and one or more past (i.e., previous) digital image(s).

Where changes in the consumer's skin type indicate one or more desired skin type transformations—i.e., from dry to oily; from sensitive to resistant; from pigmented to non-pigmented; from wrinkle-prone to tight; from very oily to oily—the consumer receives “positive”/“reinforcing” feedback and encouragement.

In preferred embodiments, the “positive”/“reinforcing” feedback is communicated to the consumer through either or both an email or via a mobile app. The email and/or app may award the user points or badges, in recognition of the improvement (change) for achieving one or more of the desired skin type transformations. The skin health professional may receive the scores and offer the positive/reinforcing feedback in person.

Where changes in the consumer's skin type indicate that one or more desired skin type transformations is occurring and the skin type is improving by changing to a skin type closer to the “ideal” skin type (ORNT), the consumer receives one or more awards or badges to encourage continued “good” behavior and tracking. For example, the consumer/patient may receive a 10% off a voluntary cosmetic procedure because they used the proper skincare regimen and adhered to diet and sleep recommendations for 4 weeks in a row.

Where changes in the consumer's skin type indicate that one or more desired skin type transformations is not occurring, the consumer receives one or more recommendations for changes to the skincare method she/he is practicing. By way of non-limiting example, a recommendation may be made to have a facial by a skin health professional (e.g., to make up for 5 days of missed steps in the recommended skincare regimen).

As a further non-limiting example, a recommendation may be made that the consumer have a specific skincare procedure performed. Skincare procedures which may be recommended, include, but are not limited to: (i) light emitting diode (l.e.d.) light therapy; (ii) intense pulsed light (i.p.l.) therapy; (iii) laser therapy to treat (a) one or more vascular conditions selected from facial capillaries, rosacea, red scars, spider leg veins, red stretch marks, portwine stains, hemangiomas, (b) uneven pigmentation or (c) uneven skin surface topography or skin roughness (iv) mechanical exfoliation; (v) superficial, medium depth or deep chemical peels; (vi) radiofrequency treatment; (vii) ultrasound treatment; (viii) intradermal and intraepidermal injections with hyaluronic acid and derivatives thereof; (ix) cryotherapy; (x) injection of botulinum toxin; and/or (xi) facial administered by a skin health professional.

In preferred embodiments, the “progress” instrumental measurement(s) is/are performed/recorded once, preferably 7 days after a consumer STP is initially created.

In more preferred embodiments, the “progress” instrumental measurement(s) is/are performed/recorded at least twice, preferably 7 days and 30 days after a consumer STP is initially created.

In even more preferred embodiments, the “progress” instrumental measurement(s) is/are performed/recorded at least three times, preferably 7 days, 30 days, and 60 days after a consumer STP is initially created.

In other preferred embodiments, the progress instrumental measurement(s) is/are performed/recorded once per week for four weeks, and thereafter once per month.

In certain preferred embodiments, the initial and “progress” instrumental measurement(s) are stored in, or accessible through, an app. In these embodiments, “badges” are awarded, preferably monthly, in recognition of varying levels of progress in reaching and/or maintaining slightly oily, resistant, non-pigmented, tight skin.

In tracking progress, it is to be understood that transformation to the ideal skin type (ORNT) will take place over time, through a number of steps. By way of non-limiting example, skin changes may be in the following order: first dry becomes oily; then, sensitive becomes resistant; then pigmented becomes non-pigmented; and, finally, wrinkle-prone becomes tight. The transformation for W to T can take anywhere from about 6 to 12 months. The transformation from P to N can be accomplished in less time, for example, from about 12 to about 16 weeks. A change from S to R can take about 3 to 4 weeks. A change from D to 0 can often be accomplished in about seven days.

Badges can and preferably are used to measure progress in changing each of the four pairings of skin health parameters (D to O; S to R; P to N; W to T). If a skin health parameter change in a patient/consumer is taking longer than expected, a cosmetic or medical procedures may be recommended to put the patient/consumer “back on course” to achieve the desired change.

As part of the third step of the invention, reminders may be sent to the consumer to perform the “progress” instrumental measurement(s). These reminders may be sent as one or more of a notification through a mobile app, an e-mail message, a voicemail message, and/or an sms/text message.

In preferred embodiments, in addition to the at least once per week instrumental measurement, “progress” may be followed by the consumer responding to a series of questions, either online or via an app.

Where changes in the consumer's skin type indicate that one or more desired skin type transformations is not occurring, the consumer may receive an electronic message, either via app or email, querying the consumer on one or more of the following: changes in sleep pattern, diet, or level of “stress”; changes in location; whether she/he has been ill or underwent a medical procedure.

Optionally, but preferably, as a fourth step, the methods of the present invention include the step of sending at least one daily reminders, preferably two daily reminders, to a consumer/patient, to follow skincare methods and lifestyle habits appropriate (i.e., prescribed) for the consumer's skin type—namely applying one or more skincare products, getting a certain number of hours sleep, eating specific foods and taking prescribed supplements. Preferably, the reminder is sent via an app installed on a mobile telecommunications device (smart phone, tablet computer) or wearable electronic device having a display screen (watch/bracelet) and an input interface (e.g., to be used in responding to reminders) associated with/or accessible to the consumer. The app-based reminder may prompt a response, such as “completed”, “dismiss”, or “snooze” (i.e., remind at later time).

In particularly preferred embodiments, two reminders are sent corresponding to different skin regimens—the first practiced in the morning, the second practiced in the evening. Optionally, the methods of the present invention can be practiceda third time of day, such as, “after exercising” or “after work” or “after breastfeeding.” By way of non-limiting example, the reminder may query the consumer whether she/he applied the appropriate skincare products in the morning and evening (or other designated time), and if not why. In response to “why not”, the consumer may be prompted to select among the following: forgot, too busy, skin problem, or ran out of product. If the consumer responds that she/he experienced a “skin problem,” she/he is prompted to select from one or more of the following, as applicable: redness, itch, peeling, pain, and dryness. In certain embodiments, a “free form” response for “skin problem” may be input (e.g., under “other”).

A skin health professional preferably receives a communication, (for example as an email or other form of “alert”) regarding the “skin problem” experienced by the consumer and thereby can make an appropriate recommendation—for example, that the consumer should modify (or eliminate) use of certain skincare products, or substitute other skincare products. Or the patient should come in for a physical exam or a cosmetic or medical procedure. Modification of use of skincare products and lifestyle recommendations can be in terms of changing the time, frequency, location and/or amount of skincare product(s) or habit (such as sleep duration), or temporarily altering/replacing one or more skincare products, diet suggestions or supplements recommended to the consumer.

If the consumer responds that she/he did not follow the prescribed regimen—applying skincare products twice daily—for a reason other than “skin problem”, the consumer receives a “positive”/“reinforcing” message, such as, “Using the correct skincare regimen twice a day is important for achieving your skin health goal. Let's try for twice a day tomorrow. You can do it!” If the consumer/patient does not adhere to a diet plan such as reducing daily sugar intake, the consumer receives an educational message such as “Your DSNT skin suffers from acne. Reducing sugar in your diet can improve acne. You have exceeded your daily sugar allowance today, which can worsen acne. Try and exercise for 30 minutes to burn excess sugar and lower stress hormone levels which will help your skin keep acne under control.”

Others with whom a consumer chooses to share her/his progress (towards slightly oily, resistant, non-pigmented, tight skin) can also provide reinforcement via messages received through a shared online profile and/or via an app.

“Competitions” among patients/consumers with the same skin type can be used to as a source of motivation. These competitions may be conducted on a social media whereby different consumers/patients with the same skin type display their progress, for example through Instagram® or Facebook®. Persons having similar skin types can offer each other encouragement and track their progress versus others.

For example, as noted above, progress of change from the baseline skin type to the ideal skin type can be compared and scored. By way of non-limiting example, many DSNT skin types take 10 weeks to change to an ORNT skin type. Progress, displayed/tracked, for example on an app installed on a mobile telecommunications device, can show a DSNT consumer/patient that she/he is improving 10% faster than other DSNTs or 10% slower and suggest options to speed the process such as increasing sleep duration, lowering sugar in the diet and adding meditation.

1. A method for changing the skin type of a consumer/patient to slightly oily, resistant, non-pigmented and tight comprising the steps of:
(a) performing a series of baseline instrumental measurements for each of four sets of skin parameters selected from
(i) skin oiliness or dryness
(ii) skin sensitivity or lack of sensitivity
(iii) even or uneven distribution of skin pigmentation
(iv) degree of fine lines and/or wrinkles
(b) based on the baseline instrumental measurements in step (a), determining the skin type of the consumer/patient
(c) communicating the skin type in step (b) to one or more of the consumer/patient or a skin health professional or office staff and recommending a comprehensive treatment plan that includes one or more of topical skincare products, orally-administered dietary supplements, lifestyle modifications, cosmetic and medical procedures appropriate for the particular skin type of the consumer/patient
(d) conducting at least one periodic progress instrumental measurement
(e) analyzing the at least one periodic progress instrumental measurement and providing the consumer/user with either “positive”/“reinforcing” feedback or a recommendation for changing the comprehensive treatment plan
wherein the skin type is selected from the group consisting of
(i) dry, sensitive, pigmented, tight (DSPT);
(ii) dry, sensitive, non-pigmented, tight (DSNT);
(iii) dry, sensitive, pigmented, wrinkle-prone (DSPW);
(iv) dry, sensitive, non-pigmented, wrinkle-prone (DSNW);
(v) oily, sensitive, pigmented, tight (OSPT);
(vi) oily, sensitive, non-pigmented, tight (OSNT);
(vii) oily, sensitive, pigmented, wrinkle-prone (OSPW);
(viii) oily, sensitive, non-pigmented, wrinkle-prone (OSNW);
(ix) oily, resistant, pigmented, tight (ORPT);
(x) oily, resistant, non-pigmented, tight (ORNT);
(xi) oily, resistant, pigmented, wrinkle-prone (ORPW);
(xii) oily, resistant, non-pigmented, wrinkle-prone (ORNW);
(xiii) dry, resistant, pigmented, tight (DRPT);
(xiv) dry, resistant, non-pigmented, tight (DRNT);
(xv) dry, resistant, pigmented, wrinkle-prone (DRPW); and
(xvi) dry, resistant, non-pigmented, wrinkle-prone (DRNW).

2. The method of claim 1 wherein the skin type is communicated as a skin type number, where the skin type number is an Arabic numeral ranging from 1 to 16, and further wherein: DSPT is communicated as the number 1; DSNT is communicated as the number 2; DSPW is communicated as the number 3; DSNW represents 4; OSPT is communicated as the number 5; OSNT is communicated as the number 6; OSPW is communicated as the number 7; OSNW is communicated as the number 8; ORPT is communicated as the number 9; ORNT is communicated as the number 10; ORPW is communicated as the number 11; ORNW is communicated as the number 12; DRPT is communicated as the number 13; DRNT is communicated as the number 14; DRPW is communicated as the number 15; and DRNW is communicated as the number 16.

3. The method of claim 2, wherein each skin type number corresponds to one of sixteen unique skin type colors, and each skin type number is communicated on products or educational materials on a background of its corresponding skin type color.

4. The method claim 1 wherein the series of baseline instrumental measurements are performed by the consumer/patient at home or in a kiosk in a retail environment.

5. The method claim 1 wherein the series of baseline instrumental measurements are performed by a skin health professional or office staff of employed by the skin health professional in a medical office or licensed skincare establishment.

6. The method claim 1 wherein the at least one periodic progress instrumental measurement is a digital image of the skin of the consumer/patient.

7. The method of claim 6 wherein the at least one periodic progress instrumental measurement is made one week after the baseline instrumental measurements.

8. The method of claim 7 wherein a plurality of periodic progress instrumental measurements are made, and among these measurements are digital image of the skin of the consumer/patient.

9. The method of claim 1 wherein “positive”/“reinforcing” feedback or a recommendation for changing the skin type is communicated to the consumer by an app installed on a mobile telecommunications device or wearable electronic device.

10. The method of claim 1 wherein the recommendation for changing the skin type is a non-invasive, cosmetic dermatological procedure selected from: (i) light emitting diode light therapy; (ii) intense pulsed light therapy; (iii) laser therapy; (iv) mechanical exfoliation; (v) superficial, medium depth or deep chemical peels; (vi) radiofrequency treatment; (vii) ultrasound treatment; and (viii) intradermal/intraepidermal injection of a dermal filler and/or neuromuscular blocking agent.

11. A method for changing the skin type of a consumer/patient to slightly oily, resistant, non-pigmented and tight comprising the steps of:
(a) using a clinically-validated questionnaire determining each of four sets of skin parameters selected from
(i) skin oiliness or dryness
(ii) skin sensitivity or lack of sensitivity
(iii) even or uneven distribution of skin pigmentation
(iv) degree of fine lines and/or wrinkles
(b) based on the skin parameters from step (a), determining the skin type of the consumer/patient
(c) communicating the skin type in step (b) to one or more of the consumer/patient or a skin health professional or office staff and recommending a comprehensive treatment plan that includes one or more of topical skincare products, orally-administered dietary supplements, lifestyle modifications, cosmetic and medical procedures appropriate for the particular skin type of the consumer/patient
(d) conducting at least one periodic progress measurement
(e) analyzing the at least one periodic progress measurement and providing the consumer/user with either “positive”/“reinforcing” feedback or a recommendation for changing the comprehensive treatment plan
wherein the skin type is selected from the group consisting of
(i) dry, sensitive, pigmented, tight (DSPT);
(ii) dry, sensitive, non-pigmented, tight (DSNT);
(iii) dry, sensitive, pigmented, wrinkle-prone (DSPW);
(iv) dry, sensitive, non-pigmented, wrinkle-prone (DSNW);
(v) oily, sensitive, pigmented, tight (OSPT);
(vi) oily, sensitive, non-pigmented, tight (OSNT);
(vii) oily, sensitive, pigmented, wrinkle-prone (OSPW);
(viii) oily, sensitive, non-pigmented, wrinkle-prone (OSNW);
(ix) oily, resistant, pigmented, tight (ORPT);
(x) oily, resistant, non-pigmented, tight (ORNT);
(xi) oily, resistant, pigmented, wrinkle-prone (ORPW);
(xii) oily, resistant, non-pigmented, wrinkle-prone (ORNW);
(xiii) dry, resistant, pigmented, tight (DRPT);
(xiv) dry, resistant, non-pigmented, tight (DRNT);
(xv) dry, resistant, pigmented, wrinkle-prone (DRPW); and
(xvi) dry, resistant, non-pigmented, wrinkle-prone (DRNW).

12. A method for tracking the progress of a genetically determined skin type changing from dry to oily, sensitive to resistant, pigmented to non-pigmented and wrinkle prone to tight skin type.

13. A method for educating and encouraging a patient/consumer to follow a comprehensive treatment plan including a skincare regimen to change a genetically determined skin type to a skin type closer to the ideal type ORNT, wherein the patient/consumer is able to change one or more of dryness to slightly oily, sensitivity to non-sensitivity (resistance), pigmented to non-pigmented and wrinkled to tight.
